(19) United States
(12) Patent Application Publication
(10) Pub. No.: US 2007/0261251 A1
(43) Pub. Date: Nov. 15, 2007

(54) Battery Recharging Heated Utility Knife with Replaceable Blade

(76) Inventor: Christopher Crawford, Otsego, MI (US)

Correspondence Address: LITMAN LAW OFFICES, LTD., P.O. BOX 15035, CRYSTAL CITY STATION, ARLINGTON, VA, 22215, US

(21) Appl. No.: 11/684,854

(22) Filed: Mar. 12, 2007

Related U.S. Application Data
(60) Provisional application No. 60/799,626, filed on May 11, 2006.

(51) Int. Cl. B26B 3/00

(52) U.S. Cl. 30/140

(57) ABSTRACT

A heated knife comprising a knife member, a handle affixed to the knife and having a hollow axial space for holding a rechargeable battery and a heating element conductor for providing an electrical connection between the battery and the heating element.

### CROSS REFERENCE TO RELATED APPLICATION

This application claims benefit to provisional application 60/799,626 filed on May 11, 2006, entitled Battery Recharging Heated Utility Knife with Replaceable Blade which is incorporated by referenced herein in its entirety.

### FIELD OF THE INVENTION

The present invention is directed to the field of knives. In particular, the invention is directed to a knife that can be electrically heated by means of a removable, rechargeable battery.

### BACKGROUND OF THE INVENTION

It is often desirable, particularly in the area of spreadable foods, to use a pre-heated knife. This frequently makes the spreadable item more uniform in texture and consistency. There have been a number of patents directed to the area of powered or heated utility knives.

U.S. Pat. No. 6,454,427 is directed towards and illuminating utility knife with an easy-access to spare blades contained therein. The knife has a housing made up of a first cover and a second cover coupled together and fastened by at least one screw. A blade is slidably contained in the housing. The utility knife of the invention can be used in dim light because an illuminating device is provided in the knife. The illuminating device includes a bulb installed near the blade, a battery chamber defined in the housing for containing at least one battery, and a switch used for actuating the bulb. Additionally, a spare blade drawer is provided and slidably contained in a passage defined in the housing. At least one spare blade is stored in the spare blade drawer and therefore is easy to be taken out.

U.S. Pat. No. 5,208,895 is directed towards a hand-self heated scraper with steaming capabilities for use in removing pain, wallpaper and adhesively glued down materials (such as linoleum or tile). The apparatus includes a housing accommodating a heating unit and steam generator, an electric water pump and two alternative base units for attaching a scraper blade, communicating steam to a work surface, or both.

U.S. Pat. No. 4,238,664 is direct towards a burn-in knife of furniture repair has an electrically heated blade and is provided with an adjustable edge guide assembly mounted on the knife handle for supporting the knife on a workpiece and maintaining the working edge of the blade at a predetermined distance from the workpiece. The guide assembly includes a heat-isolative guide means arranged in side-by-side relationship to the working edge of the blade and out of the working path thereof. The guide means lies in the same plane as the blade and has a straight edge adapted to engage the workpiece. The guide means is selectively adjustable both vertically and rotationally relative to the working edge of the blade.

U.S. Pat. No. 5,438,758 is directed towards a heated knife comprising a handle; a cutting blade formed of a thermally conductive material having a tip end and a base end with the base end couple to the handle; a heating element formed of a thermally conductive material disposed within the cutting blade with a portion thereof extended from the base end of the cutting blade; a power source coupled to the handle with the power source adapted to energize the heating element; and a switch coupled between the heating element and the power source and connected to the handle with the switch having one orientation for de-energizing the heating element and another orientation for energizing the heating element, whereby, allowing the cutting blade to be heated.

U.S. Patent Application No. 20010027968 is directed towards a handyman's tool which combined the utility of a pocket knife with the power of a cautery. It has a cautery filament installed on the cutting edge of the blade with wiring leading through the shaft of the blade to a AA-size battery pack which also serves as the handle of the knife. With just two standard AA-size batteries, the cautery filament can heat to a scorching, red-hot 2,200 degrees Fahrenheit. The cautery can be activated only when the knife is in the extended and locked back position, and a spring-loaded switch is pressed. Therefore, the knife is extremely safe and will not turn on if left alone or dropped. It has unlimited utility, and is particularly valuable for the handyman, cook and hobbyist.

U.S. Design Patent No. D376,090 is directed towards an ornamental design for a design for a knife with heated blade, as shown.

It is an object of the present invention to provide an electric knife.

It is a further object of the present invention to provide an electric knife which can be plugged in to a car.

It is a further object of the invention to provide a portable heating knife which can be powered by a rechargeable heated knife.

### SUMMARY OF THE INVENTION

In accordance, the invention is a heated knife comprising a knife member, a handle affixed to the knife and having a hollow axial space for holding a rechargeable battery, a heating element and a conductor for providing an electrical connector between the butter and the heating elements.

In a further embodiment, the present invention is a heated knife comprising a knife member, a handle affixed to the knife and having a hollow axial space for holding a rechargeable battery, a heating element, a conductor for providing an electrical connection between the electrode battery and the heating element and an on/off switch.

In yet a further embodiment, the present invention is a heated knife comprising a knife member, a handle affixed to the knife and having a hollow axial space with electrodes for holding a rechargeable battery, a heating element attached to the knife, a conductor for providing an electrical connection between the electrode battery and the heating element and an on/off switch.

### BRIEF DESCRIPTION OF THE FIGURES

FIG. 1 is a perspective view of the heated knife of the present invention.

FIG. 2 is a section view of the heated knife of the present invention.

### DETAILED DESCRIPTION OF THE PRESENT INVENTION

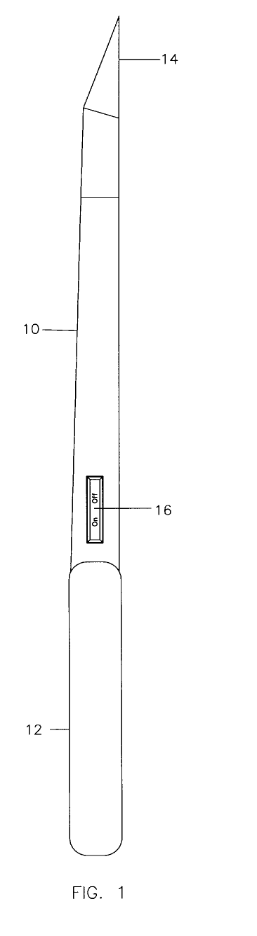

The present invention is described with reference to enclosed Figures, whereby the same numbers are used where applicable. Referring to FIG. 1, the invention is a knife 10 having a handle 12 and blade 14 with an on/off button 16.

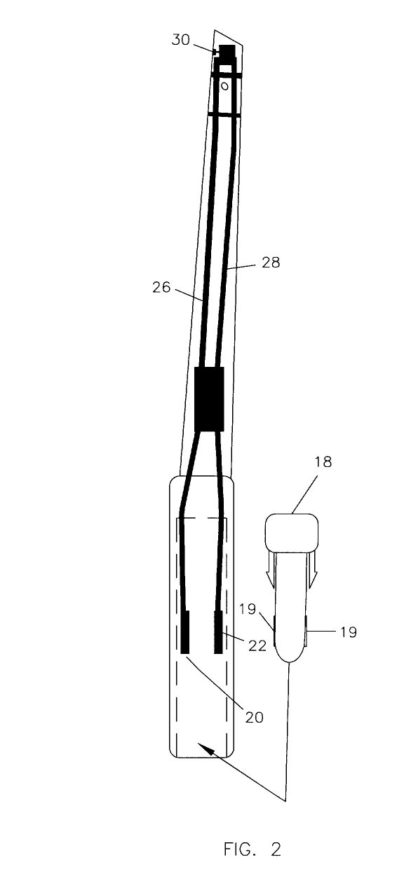

FIG. 2 is an internal view of the present invention. The main components of the invention include a handle which houses a rechargeable battery 18 charged via a car battery charger outlet. The rechargeable battery 18 is inserted axially into the knife handle and held in place by the interior walls of the handle.

The battery electrodes 19 contact two conductors 20, 22 that are situated within the handle. The conductors are attached to the on/off switch 16. The two conductors 20,22 then attach to electric wires 26,28, which further attach to a heating element 30. A thermal barrier separates the heating element from the knife. When the on/off switch is activated, the heating element heats the knife.

The present invention has been described with reference to the Figures. The true nature of the invention is to be determined with reference to the attached claims.

I claim:

1. A heated knife comprising:
a knife member;
a handle affixed to said knife member further comprising a hollow axial space for holding a rechargeable battery;
a heating element; and
a conductor for providing an electrical connector between a battery and said heating element.

2. The heated knife of claim 1 further comprising a switch which is capable of turning said heating element on and off.

3. A heated knife comprising:
a knife member;
a handle affixed to said knife member further comprising a hollow axial space for holding a rechargeable battery;
a heating element;
a conductor for providing an electrical connection between an electrode battery and said heating element; and
a switch which is capable of turning said heating element on and off.

4. A heated knife comprising:
a knife member;
a handle affixed to said knife member further comprising a hollow axial space with electrodes for holding a rechargeable battery;
a heating element separated by a barrier and attached to said knife member;
a conductor for providing an electrical connection between an electrode battery and said heating element; and
a switch which is capable of turning said heating element on and off.
